(19) United States
(12) Patent Application Publication
(10) Pub. No.: US 2019/0370027 A1
(43) Pub. Date: Dec. 5, 2019

(54) DATA LENS VISUALIZATION OVER A BASELINE VISUALIZATION

(71) Applicant: Microsoft Technology Licensing, LLC, Redmond, WA (US)

(72) Inventors: Terence Hung Bun Lee, Sammamish, WA (US); Neha Bajpai, Sammamish, WA (US); Ade William, Redmond, WA (US)

(21) Appl. No.: 15/994,618

(22) Filed: May 31, 2018

(51) Int. Cl. G06F 9/451; G06F 3/0484; G06F 21/31; G06T 11/20

(52) U.S. Cl. CPC G06F 9/451; G06F 3/04842; G06T 2200/24; G06T 11/206; G06F 21/31

(57) ABSTRACT

A baseline visualization is parsed to identify visual elements in the baseline visualization. A user interface allows a user to configure a lens overlay that associates an overlay shape, with corresponding data obtained through an API, from an external source. The data and shape in the lens overlay are also associated with a visual element in the baseline visualization. The lens overlay is separate from the baseline visualization. When the baseline visualization is displayed, the lens overlay, is displayed concurrently with the baseline visualization so that shapes in the lens overlay are displayed at a configured location and position relative to visual elements in the baseline visualization.

### BACKGROUND

Computing systems are currently in wide use. Many such computing systems allow an author to generate a document that has shapes, drawings, or similar visual elements connected by connectors. It is sometimes desired that data be displayed along with those shapes.

By way of example, a drawing application may allow a user to generate drawings with shapes and connections between the shapes. Each shape in the drawings may represent a different area of a building. The user may then wish to have data associated with each shape, such as the status of a door lock (e.g., whether it is locked or unlocked) at that portion of the building.

Other drawings may be flow charts where each shape in the flow chart represents a different phase of an operation. The user may wish to also display data on the flow chart where the data corresponds to the time spent during a given operation associated with each shape in the flow chart.

Some current systems allow this type of data to be obtained and embedded in the drawing document, itself, (e.g., in the baseline visualization). Therefore, the data becomes part of the document itself. This makes changes to the underlying document difficult, without affecting the data. Further, these types of current systems often allow obtaining data in a very specific way, that is specific to the document, and to the application that was used to create the document.

The discussion above is merely provided for general background information and is not intended to be used as an aid in determining the scope of the claimed subject matter.

### SUMMARY

A baseline visualization is parsed to identify visual elements in the baseline visualization. A user interface allows a user to configure a lens overlay that associates an overlay shape, with corresponding data obtained through an API, from an external source. The data and shape in the lens overlay are also associated with a visual element in the baseline visualization. The lens overlay is separate from the baseline visualization. When the baseline visualization is displayed, the lens overlay, is displayed concurrently with the baseline visualization so that shapes in the lens overlay are displayed at a configured location and position relative to visual elements in the baseline visualization.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a computing system architecture.

FIGS. 1A-1C illustrate a baseline visualization and two different lens overlays on the baseline visualization.

FIG. 2 is a block diagram showing one example of a lens overlay configuration system.

FIG. 3 is a flow diagram illustrating one example of the operation of the lens overlay configuration system shown in FIG. 2.

FIG. 4 is a block diagram of one example of a lens overlay generation and display system.

FIGS. 5A-5C (collectively referred to herein as FIG. 5) illustrate a flow diagram showing one example of the operation of the architecture shown in FIG. 1 and the system shown in FIG. 4 in generating a baseline visualization and a lens overlay.

FIG. 6 is a block diagram showing one example of the architecture illustrated in FIG. 1, deployed in a cloud computing architecture.

FIGS. 7-9 show examples of mobile devices that can be used in the architectures shown in the previous figures.

FIG. 10 is a block diagram showing one example of a computing environment that can be used in the architectures shown in the previous figures.

### DETAILED DESCRIPTION

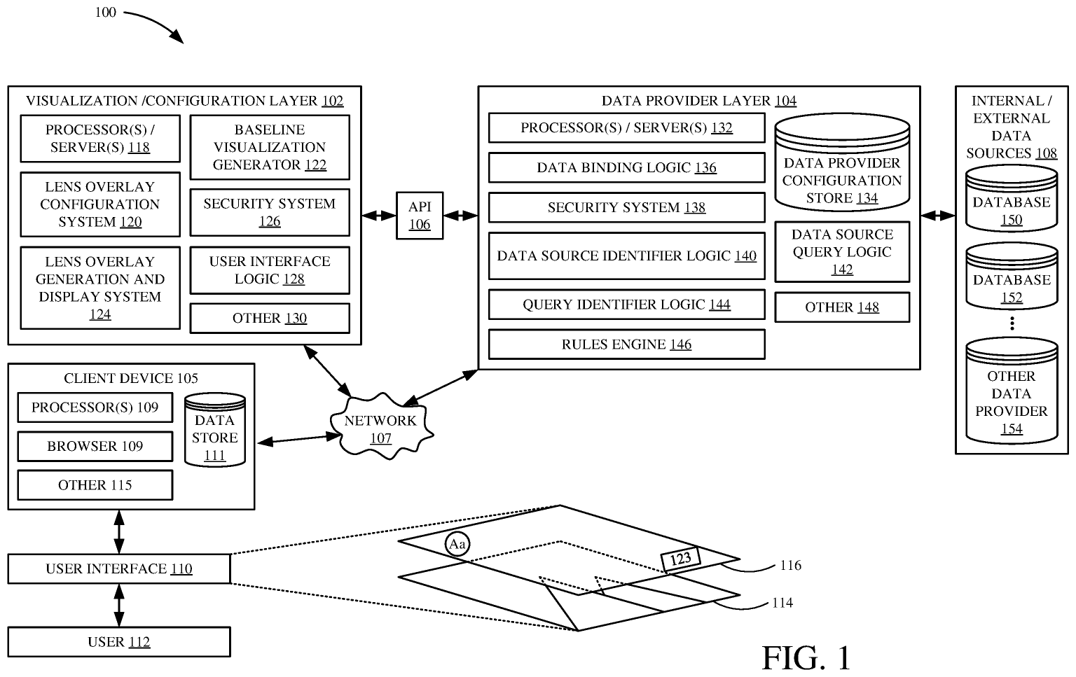

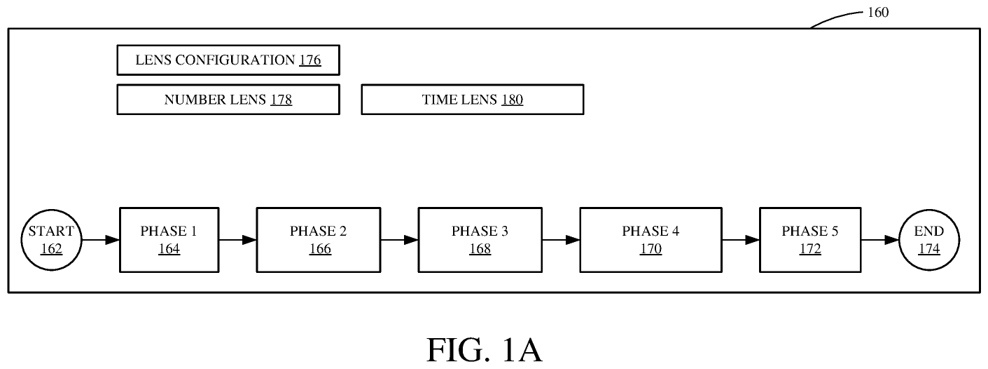

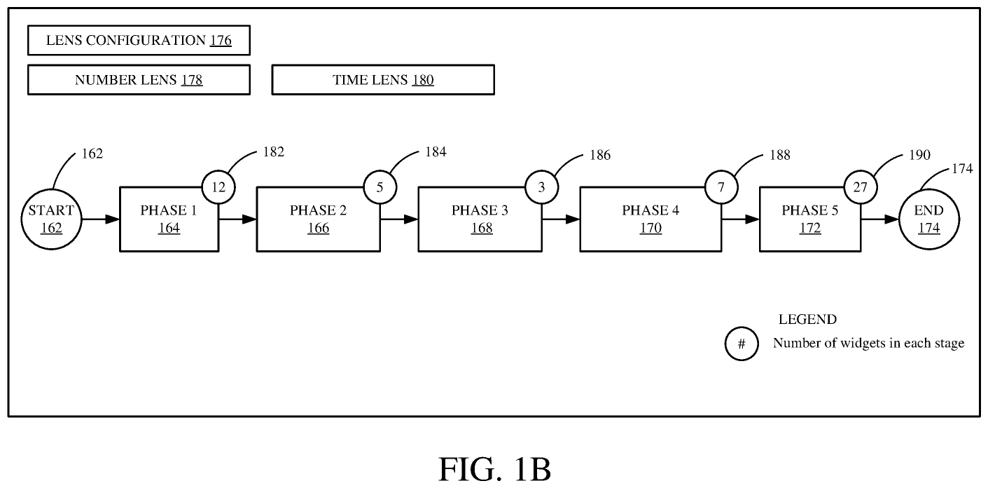

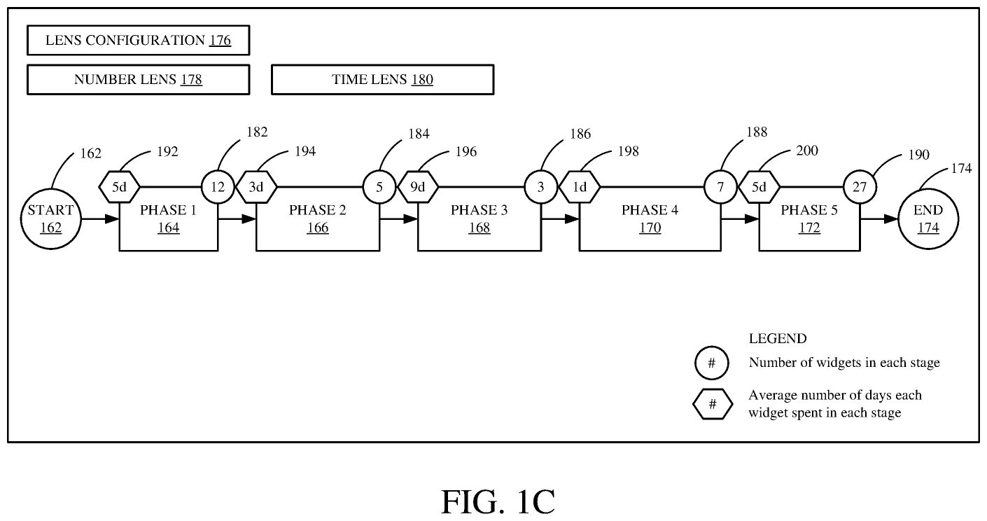

FIG. 1 is a block diagram of one example of a computing system architecture 100. Architecture 100 includes visualization/configuration layer (or system) 102, data provider layer (or system) 104 that exposes an application programming interface (API) 106, and internal/external data sources 108. Architecture 100 also includes client device 105 connected to systems 102 and 104 over network 107. In the example shown in FIG. 1, client device 105 is shown displaying one or more user interfaces 110 for interaction by user 112. The user interfaces 110 illustrated in FIG. 1 include a baseline visualization 114 and a lens overlay visualization 116 that can be displayed over the top of baseline visualization 114. As is described in greater detail below, the lens overlay visualization is a separate visualization layer from the baseline visualization so that changes to visual elements in the lens overlay visualization do not affect visual elements in the baseline visualization. Additional examples of this are shown and described in more detail below with respect to FIGS. 1A-1C.

Network 107 can be a wide area network, a local area network, a cellular communication network, a near field communication network or any of a wide variety of other networks or combinations of networks. The various items connected to network 107 have communication systems so they can communicate over network 107.

Visualization/configuration layer 102 illustratively includes one or more processors or servers 118, lens overlay configuration system 120, baseline visualization generator 122, lens overlay generation and display system 124, security system 126, user interface logic 128, and it can include other items 130. Data provider layer 104 can include one or more processors or servers 132, data provider configuration store 134, data binding logic 136, security system 138, data source identifier logic 140, data source query logic 142, query identifier logic 144, rules engine 146, and it can include other items 148. Internal/external data sources 108 can include one or more internal or external databases 150-152, along with a wide variety of other data providers 154 that can return results from an API call. Client device 105 can include one or more processors 109, data store 111 and it can run browser 113. It can also include a wide variety of other items 115. Before describing the overall operation of architecture 100 in more detail, a brief overview of some of the items in architecture 100, and their operation, will first be provided.

It is first assumed that user 112 logs into visualization/configuration layer 102 in order to view or author a document that has visual elements displayed therein, such as shapes, connectors, etc. The document may be a drawing generated from a web application that has a user interface generated by a server side component in layer 102 and displayed to user 112 in browser 113. The web application may be a drawing application, or another type of application that can generate documents with shapes, connectors, etc. Security system 126 illustratively enforces security permissions and other security mechanisms so that user 112 only has access to information for which user 112 is authorized. Baseline visualization generator 122 may be part of the web application and retrieves the document representing the baseline visualization 114 that user 112 has requested to see. In one example, the baseline visualization 114 is displayed with a configuration actuator that user 112 can actuate in order to configure a lens overlay 116 that is to be displayed on top of baseline visualization 114. In that case, lens overlay configuration system 120 generates a configuration user interface that allows user 112 to configure the lens overlay. For instance, the user may illustratively identify the type of shapes that are to be used on the lens overlay, the data that is to be displayed within each shape, the relative position on baseline visualization 114 that the element is to be displayed over, etc. In addition, the user can configure data provider layer 104 by identifying the data source, indicating which particular data source 118 is to be accessed in order to obtain the data for the lens overlay. The user can further configure data provider 104 by defining how to connect the data source and logic that will be used to aggregate data or combine data in other ways. The user can also configure lens overlay generation and display system 124 by identifying API calls that need to be made to obtain the data for the lens overlay, and providing position information indicating how the lens overlay is to be displayed, relative to the position of visual elements on the baseline visualization. Further, system 120 configures system 124 by receiving information defining rules that will be used to further define the shapes, colors and other visual characteristics of the lens overlay 116, among other things. The configuration data for data provider layer 104 can be stored in data store 134 or elsewhere. The configuration data for system 124 can be stored on layer 102 or elsewhere.

When the user 112 subsequently pulls up the baseline visualization, it will illustratively have a lens overlay selector actuator displayed on it for every lens overlay that user 112 has configured to go with that baseline visualization 114. When the user selects one or more lens overlays (by actuating the corresponding actuator on the baseline visualization 114), then lens overlay generation and display system 124 illustratively performs operations in order to generate and display the lens overlay over the baseline visualization 114.

In doing so, system 124 illustratively generates an API call to API 106 that is exposed by data provider layer 104. The API call will illustratively identify the particular lens overlay for which data is being requested. In response to the API call, security system 138 illustratively again enforces security permissions and other security mechanisms so that user 112 cannot obtain access to data that he or she is not authorized to access (even in a lens overlay display). Data source identifier logic 144 then identifies the particular data source 108 that will be needed to service the API call. Query identifier logic 144 identifies a query, from data provider configuration store 134, that will need to be executed against the identified data source in order to respond to the API call. Data source query logic 142 then executes that query (or queries) against the data source or data sources 108 and obtains query results. Rules engine 146 can identify and execute any rules that are to be executed on the results. Again, this information can be obtained from data provider configuration store 134. The query results, and the results of executing any rules, are provided to data binding logic 136 which binds that data to the shapes in the lens overlay that is being processed, and returns that information in response to the API call. Lens overlay generation and display system 124 then generates the lens overlay display 116 and displays it over the top of the baseline visualization 114.

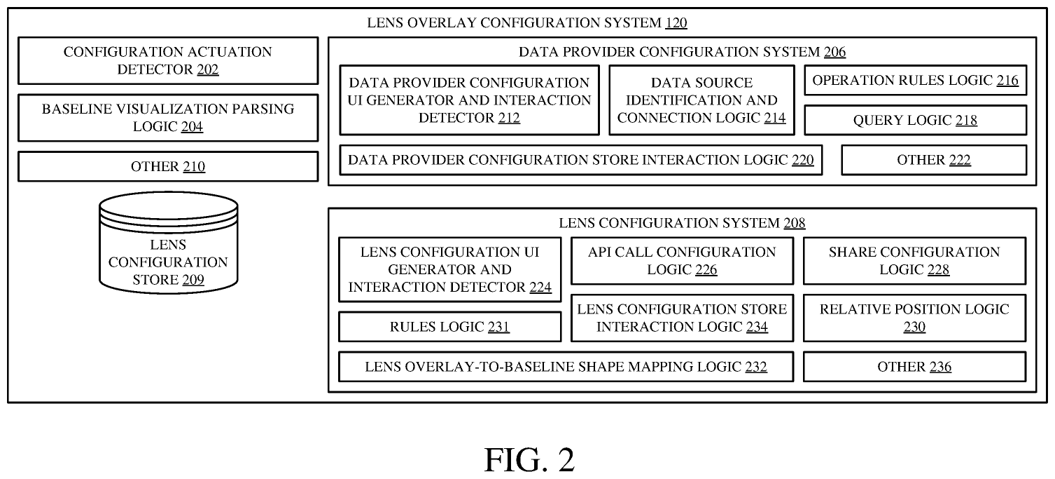

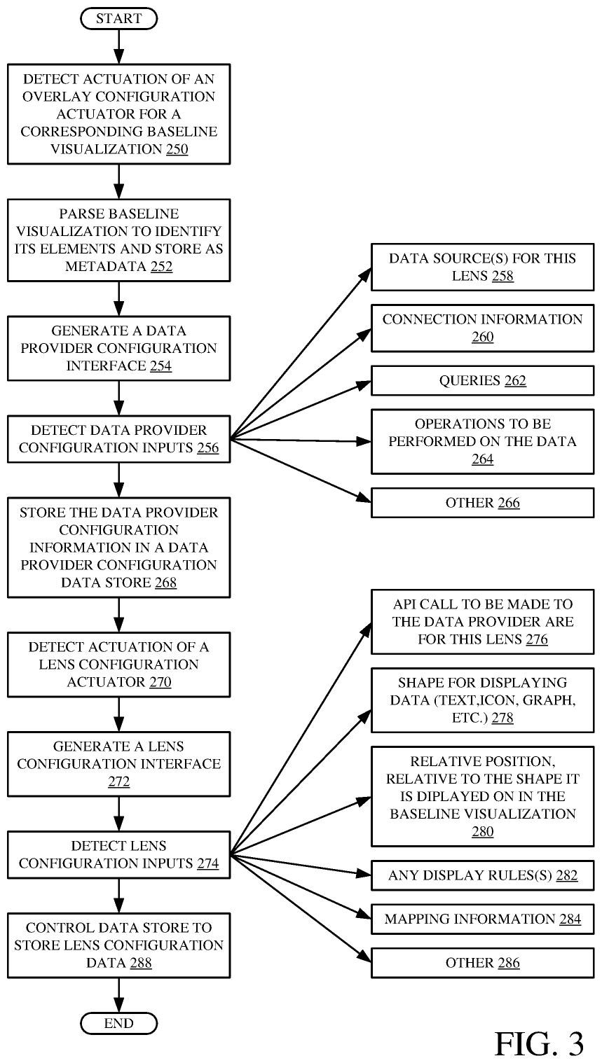

FIGS. 1A-1C show a more detailed example of a baseline visualization and a set of lens overlays. In the example shown in FIG. 1A, a baseline visualization 160 has a plurality of visual shapes or display elements 162-174 connected by connectors. In the example shown, the baseline visualization 160 was authored and is displayed using a web application, and the shapes 164-172 each represent a phase in a manufacturing process (for the sake of example only). It also illustratively has a lens configuration actuator 176, a number lens actuator 178 and a time lens actuator 180. In the example shown in FIG. 1A, a user has already configured a number lens overlay and a time lens overlay for the baseline visualization 160. Therefore, when the user actuates number lens actuator 178, then lens overlay generation and display system 124 generates and displays a number lens overlay over the top of baseline visualization 160. When the user actuates the time lens actuator 180, then lens overlay generation and display system 124 generates and displays a time lens overlay over the top of the baseline visualization 160. If the user actuates the lens configuration actuator 176, then lens overlay configuration system 120 surfaces a configuration user interface that allows user 112 to either modify one of the lens overlays that he or she has already created, or to generate a new lens overlay corresponding to the baseline visualization 160. This is described in more detail below with respect to FIGS. 2-3.

FIG. 1B is similar to FIG. 1A, and similar items are similarly numbered. However, in FIG. 1B, it can be seen that the user has actuated the number lens actuator 178. When configuring the number lens overlay, user 112 indicated that, for each phase in the process represented by shapes 164-172 in the baseline visualization 160, data corresponding to the number of items (e.g., widgets) in each phase of the manufacturing process is to be obtained by data provider layer 104, from a particular data source, and that shapes 182-190 are to be displayed in the upper right corner of the underlying shapes 164-172 in the baseline visualization, respectively. The user 112 also configured the lens overlay so that each shape includes numeric data indicative of a number of items in each phase of the manufacturing process represented by the underlying display elements 164-172. Therefore, it can be seen that each shape 182-190 in the number lens overlay has a number in it indicative a number of items that are in each of the underlying phases. That number data is illustratively obtained by data provider layer 104 and returned in response to an API call 106 generated by lens overlay generation and display system 124.

FIG. 1C is similar to FIG. 1B, and similar items are similarly numbered. However, FIG. 1C shows an example in which the user has now also actuated the time lens actuator 180. When the user 112 configured the time lens overlay, the user indicated that data provider layer 104 was to obtain a time value corresponding to the average time that each item spent in each phase of the manufacturing process identified by blocks 164-172. Therefore, when the user actuates time lens actuator 180, lens overlay generation and display system 124 identifies a particular API call that is to be made to API 106 to obtain that data. In response to the API call, data source identifier logic 140 identifies the data sources to obtain the data from. Query identifier logic 144 identifies the queries that are to be executed against those data sources, and data source query logic 142 will execute the queries, perform any aggregation defined in the logic and join multiple queries together into one resulting data set. Rules engine 146 then executes any rules. In the present example, it may be that queries that are executed against the data sources return a number of days that each item, individually, spent in each phase represented by blocks 164-172 in the baseline visualization 160. Therefore, data source query logic 142 may include an averaging rule that takes all of the times associated with each block 164-172 and averages it to obtain data for each of the display elements 192-200 in the time lens overlay shown in FIG. 1C. Data binding logic 136 binds this data to the shapes 192-200 and returns it in response to the API call. Lens overlay generation and display system 124 obtains lens configuration information indicative of the shapes that are to be displayed and the relative position where they are to be displayed, relative to the visual elements 164-172 in the baseline visualization 160, and then displays the time lens overlay as shown in FIG. 1C. All of these things are described in greater detail below.

The operation of lens overlay configuration system 120 will now be described in greater detail with respect to FIGS. 2 and 3. FIG. 2 is a block diagram showing one example of lens overlay configuration system 120, in more detail. It can be seen in the example shown in FIG. 2 that lens overlay configuration system 120 includes configuration actuation detector 202, baseline visualization parsing logic 204, data provider configuration system 206, lens configuration system 208, and it can include other items 210. Data provider configuration system 206 illustratively includes data provider configuration UI generator and interaction detector 212, data source identification and connection logic 214, operation rules logic 216, query logic 218, data provider configuration store interaction logic 220, and it can include other items 222. Lens configuration system 208 illustratively includes lens configuration UI generator and interaction detector 224, API call configuration logic 226, shape configuration logic 228, relative position logic 230, rules logic 231 (which can include business rules logic), lens overlay-to-baseline shape mapping logic 232, lens configuration store interaction logic 234, and it can include other items 236.

Configuration actuation detector 202 detects when the user actuates a lens configuration actuator (such as actuator 176 shown in FIGS. 1A-1C). This is indicative of user 112 wishing to configure a lens overlay for a particular baseline visualization. When this happens, data provider configuration UI generator and interaction detector 212 generates a data provider configuration UI that allows user 112 to configure the data provider layer 104 for the lens overlay being configured. Data source identification and connection logic 124 illustratively detects user interactions through the configuration UI, that indicate the particular data sources 108 and how data provider layer 104 can connect to those data sources, in order to provide data to the lens overlay being configured. Lens configuration UI generator and interaction detector 224 detects user inputs, through the configuration UI, of rules that are to be executed by rules engine 146 on the data retrieved from data sources 108. Query logic 218 detects user inputs through the configuration UI that specify the queries that are to be executed against the identified data sources in order to obtain the data. Data provider configuration store interaction logic 220 then stores this information in data provider configuration store 134 (shown in FIG. 1).

Baseline visualization parsing logic 204, once it is determined that a data lens overlay is to be configured for the baseline visualization, parses the baseline visualization to identify the various visual shapes and display elements in the baseline visualization. For instance, referring again to FIG. 1A, parsing logic 204 will illustratively parse the baseline visualization 160 to identify the different shapes 162-174, and the connectors between those shapes, as well as a position on the baseline visualization 160 where the shapes are displayed, and store this as metadata corresponding to the underlying baseline visualization 160. This baseline metadata can then be used when placing the visual shapes in a lens overlay, over the top of the baseline visualization.

Thus, when an API call is received through API 106, data source identifier logic 140 can access that information in data provider configuration store 134 to identify the data sources to be accessed. Query identifier logic 144 can access store 134 to identify the particular queries that are to be executed against those data sources and data source query logic 142 can execute the queries. Rules engine 146 can execute any rules that were input (and stored in store 134), and data binding logic 136 can then bind the results of the query and rules execution to the shapes in the data lens overlay, in response to the API call.

Once the data provider configuration system has obtained the desired information to configure data provider layer 104 for the lens overlay being configured, the lens configuration UI generator and interaction detector 224 generates a lens configuration UI that can be used by user 112 in order to configure the items in the lens overlay, itself. API call configuration logic 226 detects user inputs through that UI, indicating the particular API call(s) to be made when this particular lens overlay is to be displayed. Shape configuration logic 228 detects user inputs indicating the shape that is to be used, for this lens overlay, in order to display data on the baseline visualization. Relative position logic 230 illustratively detects user inputs through the configuration UI indicating the relative position where the shapes on this lens overlay are to be displayed, relative to the underlying shapes or visual elements on the baseline visualization. Lens overlay-to-baseline shape mapping logic 232 detects user inputs which map the shapes in the lens overlay to the shapes in the underlying baseline visualization. This identifies which shapes or visual elements in the baseline visualization the shapes or visual elements in lens overlay are to be displayed on. Lens configuration store interaction logic 234 then interacts with lens configurations store 209 to store the lens configuration information in store 209. In this way, when the user actuates a lens overlay actuator (e.g., 178 or 180 shown in FIG. 1A), then lens overlay generation and display system 124 can access the lens configuration store 209 to obtain the information it needs in order to generate and display the corresponding lens overlay.

FIG. 3 is a flow diagram illustrating one example of the operation of lens overlay configuration system 120, in more detail. Configuration actuation detector 202 first detects user actuation of a configuration actuator for a corresponding baseline visualization. This is indicated by block 250 in the flow diagram of FIG. 3. By way of example, it may be that user 112 is viewing a baseline visualization, such as visualization 160 shown in FIG. 1A. It may then be that the user actuates lens configuration actuator 176 indicating that user 112 wishes to configure a lens overlay for baseline visualization 160.

Parsing logic 204 then parses the baseline visualization 160 (if it has not already done so) to identify the various shapes and display elements, and their connectors and locations, in the baseline visualization 160. Parsing the baseline visualization is indicated by block 252 in the flow diagram of FIG. 3. The parsed information can be stored as baseline metadata corresponding to that baseline visualization in configuration store 209 or elsewhere in architecture 100.

Data provider configuration UI generator and interaction detector 212 then generates a data provider configuration interface that user 112 can interact with in order to configure data provider layer 104 for the lens overlay that is being configured. This is indicated by block 254 in the flow diagram of FIG. 3. The UI may have actuators that can be actuated to provide the information needed by data provider layer 104 so that it can obtain data, execute rules, bind the data to various shapes, and return that data when it is requested through an API call.

Data provider configuration system 206 then detects data provider configuration inputs that configure data provider layer 104 for the lens overlay being configured. This is indicated by block 256 in the flow diagram of FIG. 3. For instance, data source identification and connection logic 214 illustratively detects user inputs identifying the data sources that are to be accessed for this lens overlay, and connection information indicating how it is to connect to those data sources. Identifying the data sources and the data source connection information is indicated by blocks 258 and 260, respectively. Query logic 218 detects user inputs identifying the query or queries that are to be executed against those data sources. This is indicated by block 262 in the flow diagram of FIG. 3. Operation rules logic 216 reads the configuration stored in data provider configuration store 134 and executes any logical rule, such as aggregation and/or joining multiple data sources into a resulting data set. Obtaining the rules indicative of operations to be performed on the data is indicated by block 264. Data provider configuration inputs can be detected in other ways as well, and this is indicated by block 266. Once the data provider configuration information is received, data provider configuration store interaction logic 220 illustratively interacts with data provider configuration store 134 to store that information in data store 134. This is indicated by block 268 in the flow diagram of FIG. 3.

It may be that lens configuration actuator 176 is broken into two actuators, one for configuring the data provider and another for configuring the lens overlay. It can also be displayed as a single actuator, as shown in FIG. 1A. In either case, detector 202 detects that user 112 wishes to now configure the lens overlay, itself. Detecting this is indicated by block 270 in the flow diagram of FIG. 3. Lens configuration UI generator and interaction detector 224 then generates a lens configuration user interface that user 112 can interact with in order to configure the lens overlay. Generating the lens configuration interface is indicated by block 272. Detector 224 then detects user interactions with that interface indicative of lens configuration inputs that configure the lens overlay. This is indicated by block 274. For example, API call configuration logic 226 illustratively detects user inputs identifying an API call that is to be made to API 106 exposed by data provider logic 104 in order to obtain the data to generate the lens overlay being configured. This is indicated by block 276.

Shape configuration logic 228 illustratively detects user inputs through the user interface identifying the shapes that are to be displayed on this lens overlay. The shapes, for instance, can be different geometric shapes, they can be graphs (bar graphs, pie graphs, etc.), or they can be other shapes. The shapes can be text boxes as well. Identifying the shape information for displaying data on the lens overlay is indicated by block 278.

Relative position logic 230 illustratively detects user inputs identifying the relative positions that the shapes for this lens overlay are to be displayed relative to elements on the baseline visualization. This is indicated by block 280. Rules logic 231 illustratively detects user inputs identifying different display rules that are to be executed when the lens overlay is displayed. For instance, it may be that the background (or fill color) of the shape depicted on the lens overlay is to change colors if the data crosses a certain threshold value. For instance, if the data is a percentage value, and the percentage value falls below a threshold of 75%, then it may be that a rule indicates that the background or fill color of the shape is to be green whereas if the data meets or exceeds that threshold value, then the fill color is to be red. This is just one example of a rule that can be used. Detecting any display rules is indicated by block 282.

Lens overlay-to-baseline shape mapping logic 232 then detects user inputs indicative of which shapes in the baseline visualization this lens overlay corresponds to. For example, it may be that this lens overlay generates octagon shapes with a numerical data value in them, and they are to be displayed over all circle shapes in the baseline visualization. This mapping information can be provided by the user through the lens configuration interface. Logic 232 then generates a mapping that indicates that the shapes in the present lens overlay are to map to (or to be displayed on) the shapes to which they are mapped in the baseline visualization. Detecting this mapping information and generating the mappings is indicated by block 284. Lens configuration inputs can be detected in other ways, and other information can be obtained as well. This is indicated by block 286.

Lens configuration store interaction logic 234 then controls lens configuration store to store the lens configuration data that was received. This is indicated by block 288 in the flow diagram of FIG. 3.

It will also be noted that the present discussion proceeds with respect to the user providing the configuration information through the configuration user interface. Thus, the interface can have a wide variety of different user input mechanisms that can be actuated to do this. Those can include such things as dropdown menus, buttons, links, icons, text boxes, among other things. Also, default configuration information can be provided for user acceptance or modification. Similarly, some or all of the configuration information can be pre-configured or automatically configured so the user need not provide all of the configuration inputs. These and other scenarios are contemplated herein.

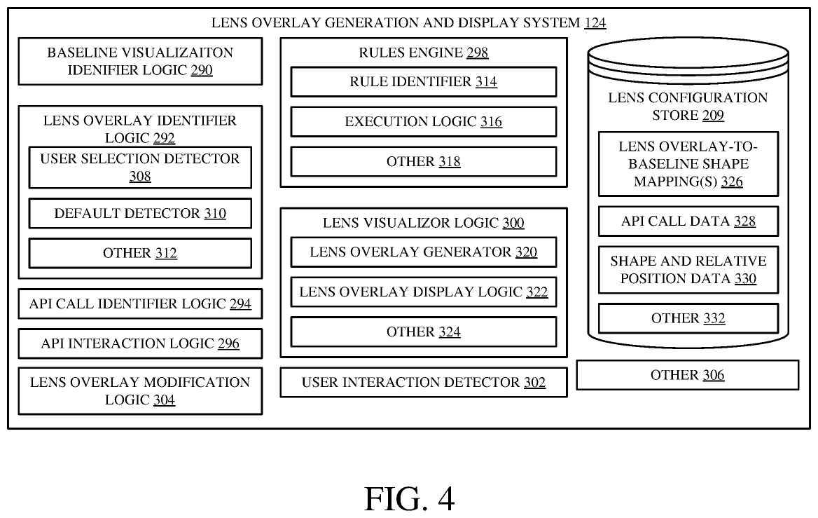

Once the visualization/configuration layer 102 and data provider layer 104 are configured, then the configured lens overlays can be displayed by lens overlay generation and display system 124. FIG. 4 is a block diagram showing one example of lens overlay generation and display system 124, in more detail. System 124 illustratively includes baseline visualization identifier logic 290, lens overlay identifier logic 292, API call identifier logic 294, API interaction logic 296, rules engine 298, lens visualizer logic 300, user interaction detector 302, lens overlay modification logic 304, and it can include other items 306. FIG. 4 also shows one more detailed example of lens configuration store 209.

Lens overlay identifier logic 292 illustratively includes user selection detector 308, default detector 310, and it can include other items 312. Rules engine 298 illustratively includes rule identifier 314, execution logic 316, and it can include other items 318. Lens visualizer logic 300 illustratively includes lens overlay generator 320, lens overlay display logic 322, and it can include other items 324. In the example shown in FIG. 4, lens configuration store 209 illustratively includes lens overlay-to-baseline shape mappings 326, API call data 328, shape and relative position data 330. It can include other items 332 as well.

Baseline visualization identifier logic 290 illustratively identifies the baseline visualization 160 for which the lens overlay is to be displayed. Lens overlay identifier logic 292 then identifies a lens overlay, corresponding to that baseline visualization, that is to be displayed. For instance, user selection detector 308 detects when a user actuates a lens overlay actuator (such as one of actuators 178 or 180 in FIG. 1A). Default detector 310 detects whether there is a default lens overlay that is to be displayed on the baseline visualization.

API call identifier logic 294 accesses lens configuration store 209 to identify the API calls that are to be made in order to display the selected lens overlay. API interaction logic 296 actually makes those API calls to API 106. Rule identifier 314 identifies any rules that are to be executed on the information returned from the API call and execution logic 316 executes those rules. The rules may be stored in data store 209, or elsewhere.

Lens overlay generator 320 generates the lens overlay based upon the various lens configuration information in data store 209 and the data returned by data provider layer 104. Lens overlay display logic 322 displays that overlay over the baseline visualization.

It may be that the user 112 interacts with the visualization (the baseline visualization or the lens overlay) in some way. In that case, user interaction detector 302 detects the user interaction so that any other processing can be performed based on that user interaction. For instance, if the user modifies the baseline visualization to delete a shape, then lens overlay modification logic 304 identifies whether the lens overlay needs to be modified as well. For instance, even though the lens overlay is a completely separate structure (visualization layer) from the baseline visualization, it may be that a lens overlay displayed a shape on a display element in the baseline visualization, and that display element has now been deleted from the baseline visualization. In that case, the lens overlay is recomputed and modified to eliminate the corresponding lens overlay shape that corresponded to that visual element that has been deleted. This is done by logic 304. It will be noted, however, that the lens overlay can be modified without affecting the baseline visualization at all. This is because the configuration information that defines the lens overlay is used to display it as a separate visualization layer and not to embed the lens overlay information into the baseline visualization, itself.

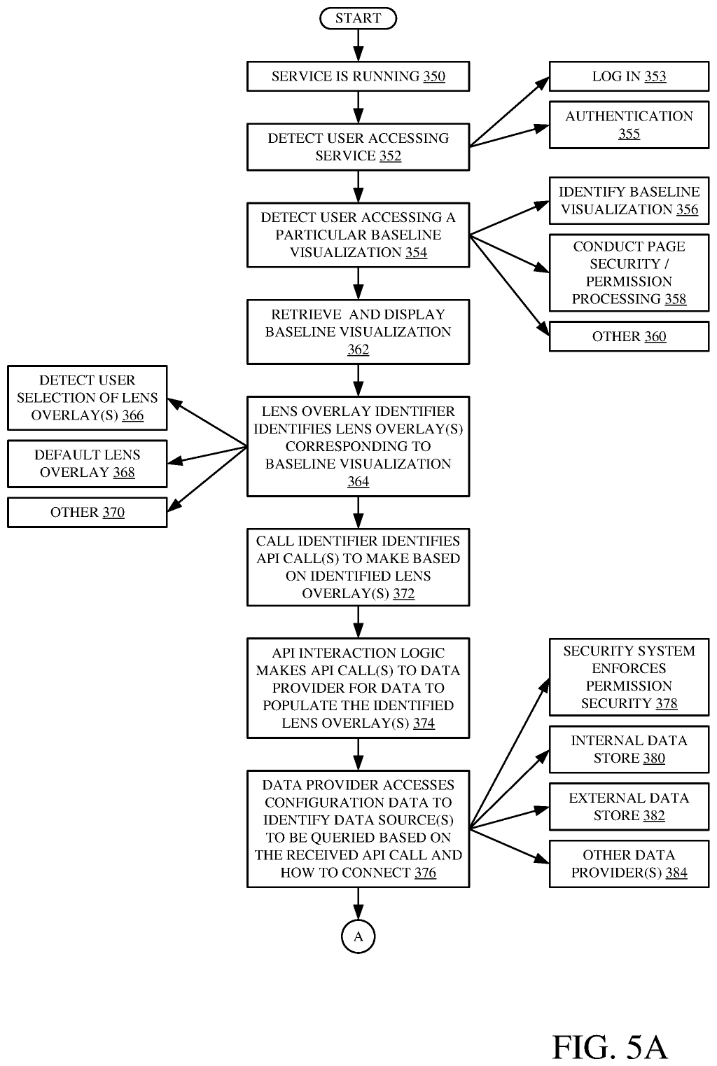

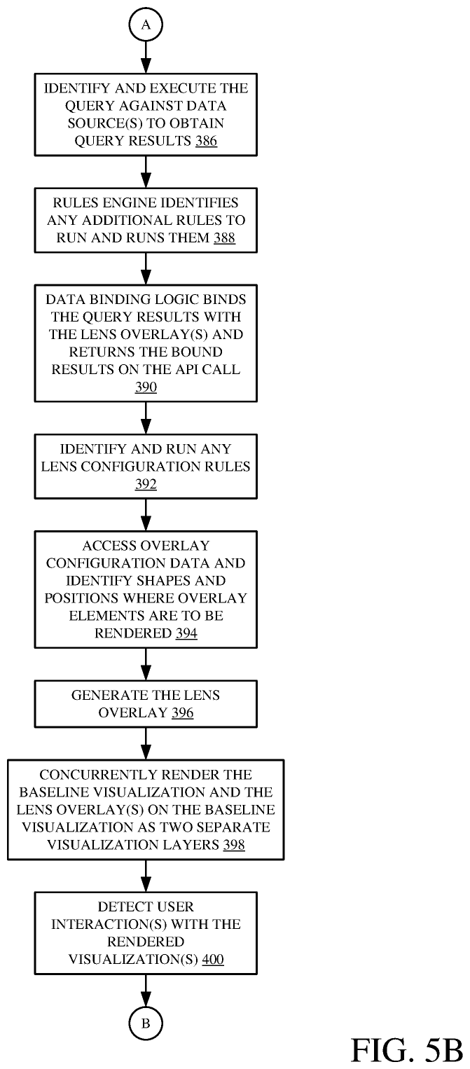

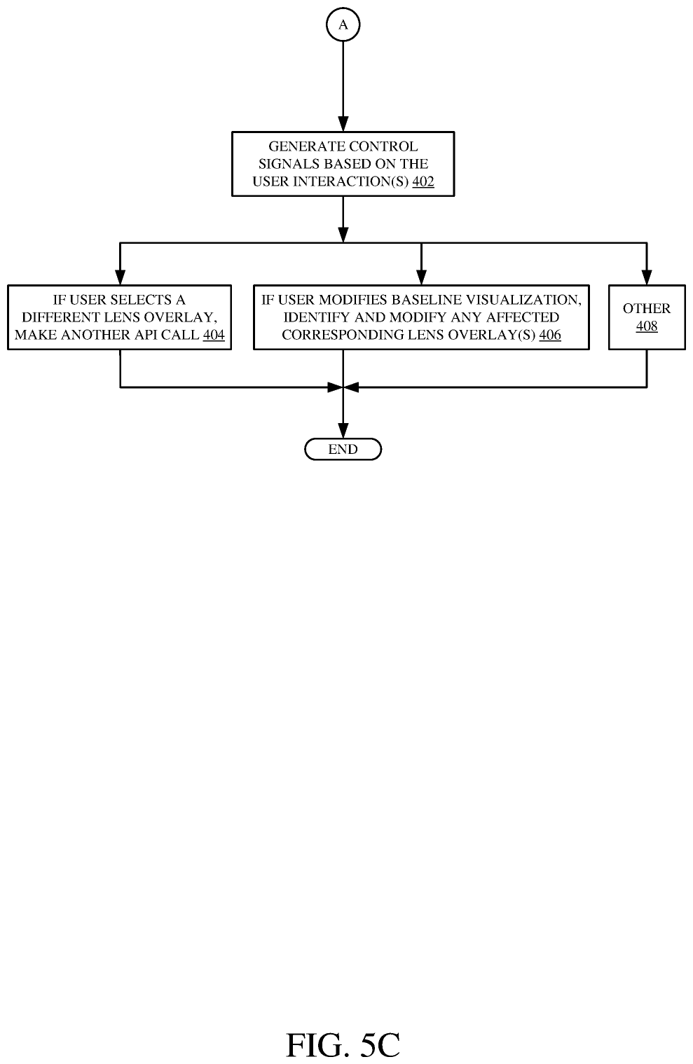

FIGS. 5A-5C (collectively referred to herein as FIG. 5) show a flow diagram illustrating one example of the operation of the architecture illustrated in FIG. 1 and system 124 shown in FIG. 4, in more detail. It is first assumed that a service or other computing system is running that includes the items shown in architecture 100. This is indicated by block 350 in the flow diagram of FIG. 5. User interface logic 128 then detects that user 112 is accessing the service. This is indicated by block 352. As discussed above, the service may provide access to a web application that is used to author and display the various visualizations discussed herein. The web application may be a drawing application, an architectural application, or a wide variety of other applications.

When a user accesses the service, security system 126 may conduct a login operation 355 and an authentication operation 357 to authenticate user 112 to the service.

User interface logic 128 then detects that the user is accessing a particular baseline visualization. This is indicated by block 354 in the flow diagram of FIG. 5. For instance, the user may navigate to a file system that contains a document representing the baseline visualization and provide an input indicating the document is to be opened. Identifying the baseline visualization being accessed by the user is indicated by block 356. Again, security system 126 illustratively performs page security and permission processing to ensure that user 112 only has access to the information for which he or she is authorized. Conducting the page security/permission processing is indicated by block 358. Detecting that the user is accessing a particular baseline visualization can be done in other ways as well, and this is indicated by block 360.

Baseline visualization generator 122 then retrieves the baseline visualization and displays it for user 112. This is indicated by block 362. The baseline visualization identifier logic 290 then identifies the baseline visualization so that lens overlays that are available to display on that baseline visualization can be identified as well. The baseline visualization will be displayed with an actuator corresponding to each lens overlay that has been configured for it. Lens overlay identifier logic 292 then identifies one or more lens overlays, corresponding to the baseline visualization, that are to be displayed. For instance, it may be that user selection detector 308 has detected user selection of a lens overlay using one of the corresponding actuators (e.g., actuators 178-180). Detecting the lens overlay is indicated by block 364 and detecting it based on a user selection is indicated by block 366. It may also be that default detector 310 detects a default lens overlay that is to be displayed on the baseline configuration. This is indicated by block 368. The lens overlay can be identified in other ways as well, and this is indicated by block 370.

API call identifier logic 294 then accesses data store 209 to identify the particular API call or calls that are to be made based on the identified lens overlay. This is indicated by block 372. API interaction logic 296 then makes the API calls on API 106, exposed by data provider layer 104, in order to obtain data to populate the identified lens overlay. This is indicated by block 374 in the flow diagram of FIG. 5.

Data source identifier logic 140 then accesses data provider configuration store 184 to identify the data sources that are to be queried based upon the received API call. This is indicated by block 376 in the flow diagram of FIG. 5. Security system 138 enforces security permissions and other security mechanisms to ensure that user 112 does not obtain access to information that he or she is not authorized to access. This is indicated by block 378. The identified data stores can be internal or external data sources or they can be other data providers as well. This is indicated by blocks 380, 382, and 384, respectively, in FIG. 5.

Query identifier logic 144 also accesses configuration store 134 to identify the particular queries that are to be executed against those data sources, and data source query logic 142 executes the queries against those data sources. Identifying the queries and executing them against the data sources is indicated by block 386 in the flow diagram of FIG. 5. It will be noted that multiple queries can be made, for a single lens overlay, to multiple different and disparate data sources or data providers. For instance, referring again to FIGS. 1A-1C, it may be that the average time data comes from different data sources for the different phases represented by blocks 164-172. In that case, the data provider will query and operate on data from the different data sources in order to return the data for the single time lens overlay. This is just one example.

Once the data is returned, rules engine 146 identifies any additional rules to run on that data, and then runs those rules. This is indicated by block 388 in the flow diagram of FIG. 5. Once the data from the queries, as well as the results of executing any rules on that data, are obtained, that information is bound to the shapes on the lens overlay by data binding logic 136 and the information is returned to the API call received at API 106. Binding and returning the results is indicated by block 390 in the flow diagram of FIG. 5.

Rule identifier logic 314 then identifies whether any lens configuration rules are to be run on the data. If so, execution logic 316 executes those rules on the data. Identifying and executing lens configuration rules is indicated by block 392 in the flow diagram of FIG. 5.

Lens visualizer logic 300 then accesses the lens configuration data store 209 to identify the shapes and relative positions 330 where the overlay elements are to be rendered, relative to the elements on the baseline visualization. This is indicated by block 394 in the flow diagram of FIG. 5. Lens overlay generator 320 then generates the lens overlay, and lens overlay display logic 322 displays that, or renders it, over the baseline visualization so that both the baseline visualization, and the lens overlay are displayed, concurrently, even though they are completely separate structures or visualization layers. Generating the lens overlay is indicated by block 396 and displaying it over the baseline visualization is indicated by block 398 in FIG. 5.

User interaction detector 302 then detects any user interactions with the rendered visualizations. This is indicated by block 400. Lens overlay generation and display system 124 then generates any control signals based on the user interactions. This is indicated by block 402. By way of example, if user selection detector 308 detects that the user has actuated another lens overlay actuator 178 or 180, then lens overlay generation and display system 124 makes another API call and generates the corresponding lens overlay and displays it over the baseline visualization as well. This is indicated by block 404.

If the user modifies the baseline visualization in such a way that any lens overlays currently being displayed should also be modified, then lens overlay modification logic 304 modifies those lens overlays as appropriate. This is indicated by block 406. Other user interactions can be detected, and other control signals can be generated as well. This is indicated by block 408.

It can thus be seen that the present description describes a system and operation which generates a lens overlay, as a wholly separate document or visualization layer, from a baseline visualization. Therefore, the two documents can be separately edited and modified in other ways. In addition, multiple lens overlays can be selected from a single baseline visualization, and a single lens overlay can be selected from multiple different baseline visualizations. This increases the flexibility, scalability, and adaptability of the system. Further, because the lens overlays are separate from the baseline visualization, the baseline visualization may be completely deleted, but the lens overlay will still be stored, so that it can be reused. Similarly, the lens overlay can be modified or deleted without changing the baseline visualization in any way. This reduces the overall file size of the baseline visualization, thus conserving storage space. Also, the lens overlay is only displayed when the user selects it. Therefore, as opposed to embedding information in the baseline visualization so that it must be retrieved and displayed every time the baseline visualization is displayed, the present description conserves computing resources and computing overhead because the lens overlays are only displayed, when selected. Also, the present description describes a system that incorporates data from any of a wide variety of data sources and received through an API call, into a lens overlay for a baseline visualization that can be natively generated by the system. The data for both are displayed concurrently but as two separate layers.

It will be noted that the above discussion has described a variety of different systems, components and/or logic. It will be appreciated that such systems, components and/or logic can be comprised of hardware items (such as processors and associated memory, or other processing components, some of which are described below) that perform the functions associated with those systems, components and/or logic. In addition, the systems, components and/or logic can be comprised of software that is loaded into a memory and is subsequently executed by a processor or server, or other computing component, as described below. The systems, components and/or logic can also be comprised of different combinations of hardware, software, firmware, etc., some examples of which are described below. These are only some examples of different structures that can be used to form the systems, components and/or logic described above. Other structures can be used as well.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms used to configure systems 102 and 104 can be text boxes, check boxes, icons, links, drop-down menus, selectable actuators, search boxes, etc. They can also be actuated in a wide variety of different ways. For instance, they can be actuated using a point and click device (such as a track ball or mouse). They can be actuated using hardware buttons, switches, a joystick or keyboard, thumb switches, a keypad or keyboard or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

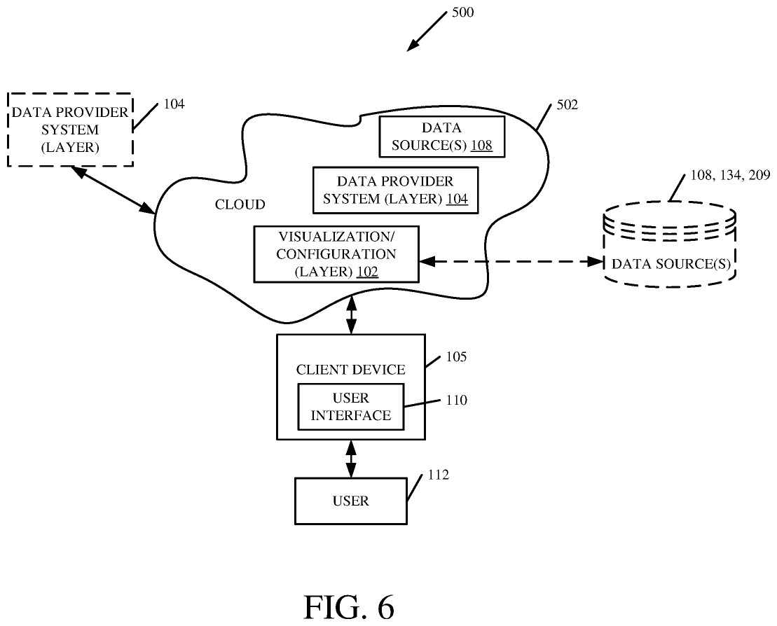

FIG. 6 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 6, some items are similar to those shown in FIG. 1 and they are similarly numbered. FIG. 6 specifically shows that computing systems (or layers) 102 and 104 and data sources 108 can be located in cloud 502 (which can be public, private, or a combination where portions are public while others are private). Therefore, user 112 uses a client device 105 to access those systems through cloud 502.

FIG. 6 also depicts another example of a cloud architecture. FIG. 6 shows that it is also contemplated that some elements of architecture 100 can be disposed in cloud 502 while others are not. By way of example, data sources 108 and data stores 134 and 209 can be disposed outside of cloud 502, and accessed through cloud 502. In another example, data provider layer 104 (or other items) can be outside of cloud 502. Regardless of where they are located, they can be accessed directly by device 105, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

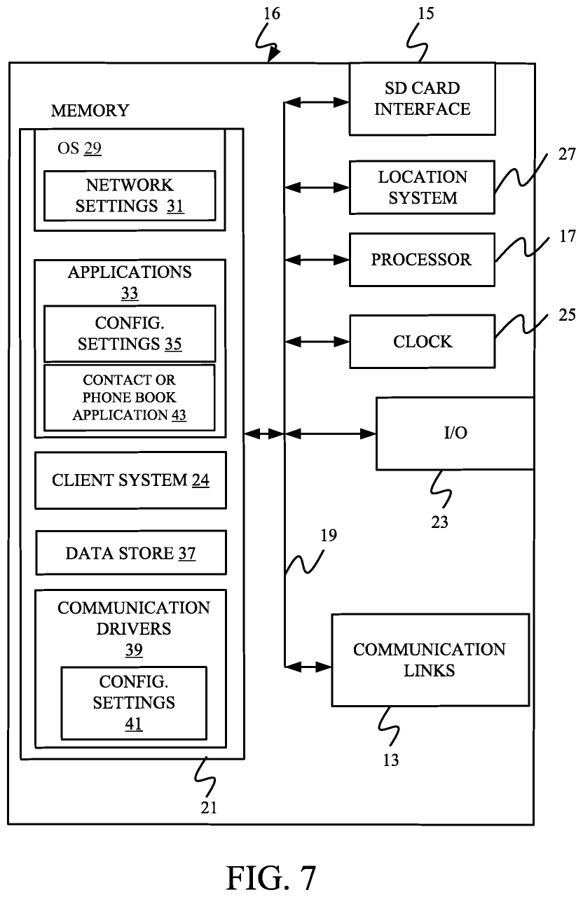

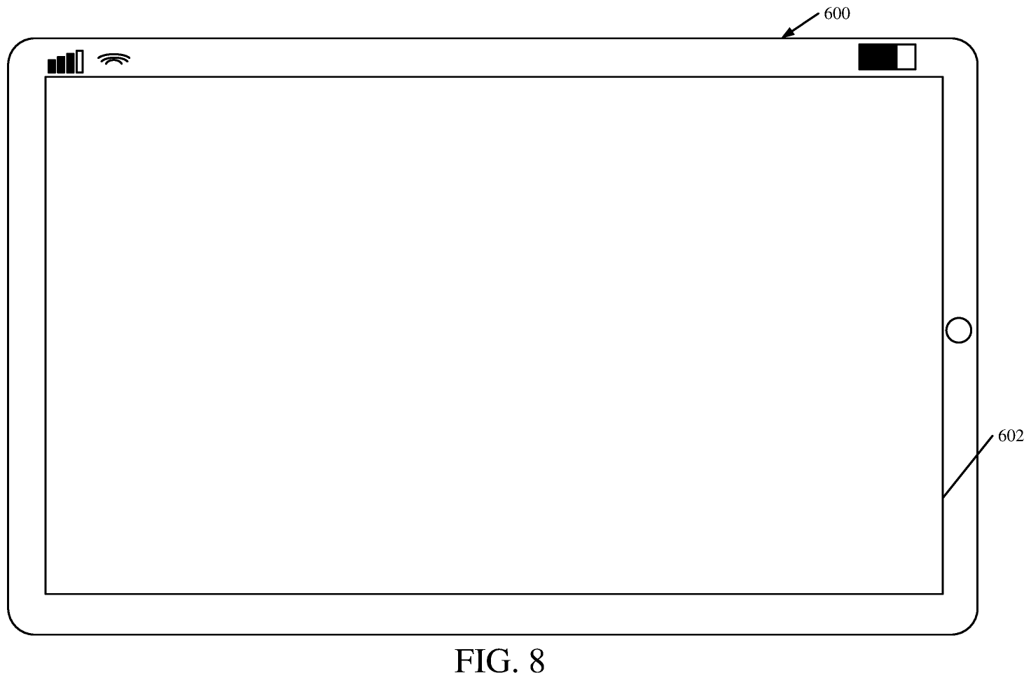

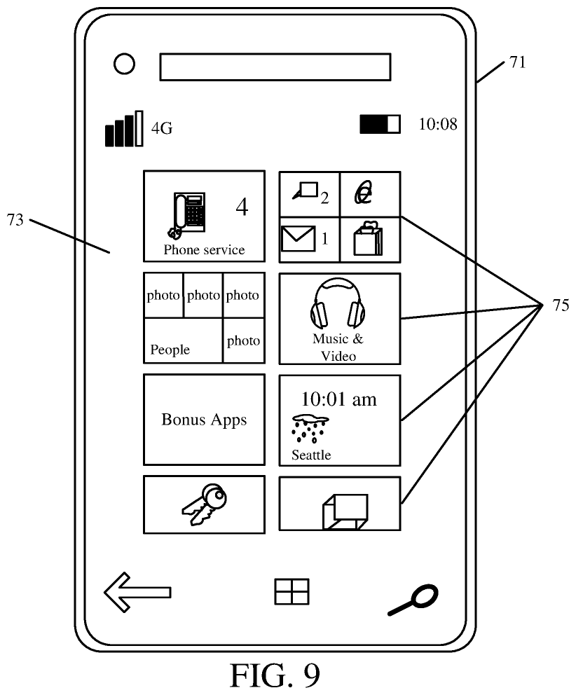

FIG. 7 is a simplified block diagram of one illustrative example of a handheld or mobile computing device that can be used as a user's or client's hand held device 16, in which the present system (or parts of it) can be deployed. FIGS. 8-9 are examples of handheld or mobile devices.

FIG. 7 provides a general block diagram of the components of a client device 16 that can run components or architecture 100 or that interacts with architecture 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as Wi-Fi protocols, and Bluetooth protocol, which provide local wireless connections to networks.

In other examples, applications or systems are received on a removable Secure Digital (SD) card that is connected to a SD card interface 15. SD card interface 15 and communication links 13 communicate with a processor 17 (which can also embody processors or servers from other FIGS.) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Similarly, device 16 can have a client system 24 which can run various applications or embody parts or all of architecture 100. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 8 shows one example in which device 16 is a tablet computer 600. In FIG. 8, computer 600 is shown with user interface display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

FIG. 9 shows that the device can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

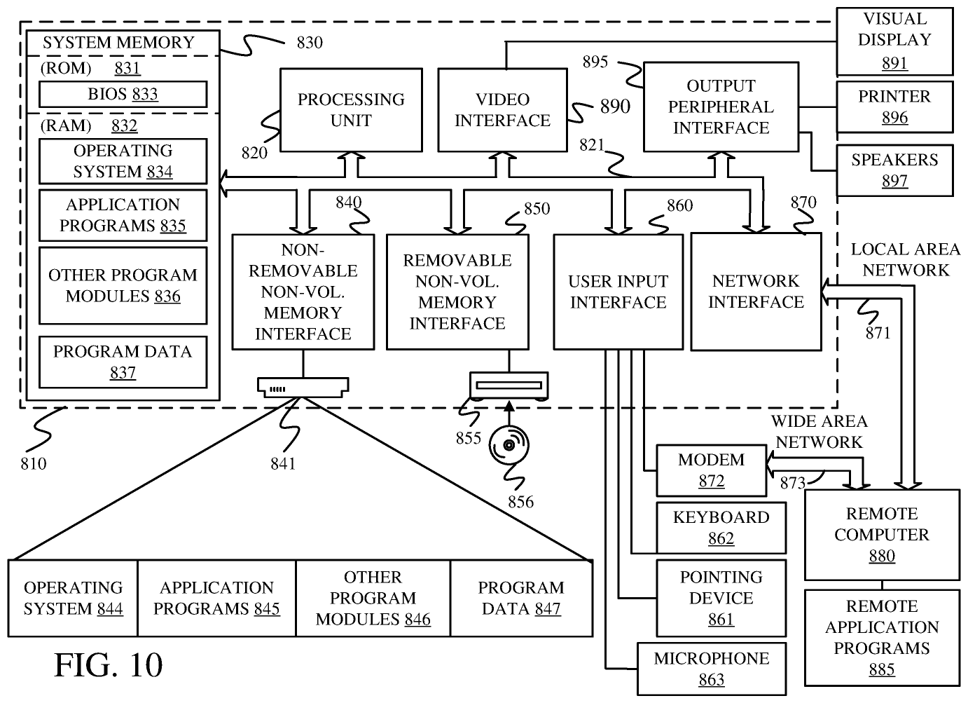

FIG. 10 is one example of a computing environment in which architecture 100, or parts of it, (for example) can be deployed. With reference to FIG. 10, an example system for implementing some embodiments includes a general-purpose computing device in the form of a computer 810. Components of computer 810 may include, but are not limited to, a processing unit 820 (which can comprise processors or servers from previous FIGS.), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 10.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 10 illustrates operating system 834, application programs 835, other program modules 836, and program data 837.

The computer 810 may also include other removable/non-removable volatile/nonvolatile computer storage media. By way of example only, FIG. 10 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 10, provide storage of computer readable instructions, data structures, program modules and other data for the computer 810. In FIG. 10, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 10 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 10 illustrates remote application programs 885 as residing on remote computer 880. It will be appreciated that the network connections shown are exemplary and other means of establishing a communications link between the computers may be used.

It should also be noted that the different examples described herein can be combined in different ways. That is, parts of one or more examples can be combined with parts of one or more other examples. All of this is contemplated herein.

Example 1 is a computing system, comprising:

a baseline visualization generator that generates a baseline visualization display, with visual elements, as a first visualization layer in a web application;

lens overlay display identifier logic that identifies a lens overlay display corresponding to the baseline visualization display;

application programming interface (API) interaction logic that makes an API call to an API, exposed by a data provider, to obtain data corresponding to the identified lens overlay display; and

a lens overlay display generator that receives the data corresponding to the identified lens overlay display and generates the identified lens overlay display including the received data, so the generated lens overlay is displayed concurrently with the baseline visualization display, as a second visualization layer in the web application, that is independently modifiable, independently of the first visualization layer, so the visual elements in the first visualization layer remain unchanged by changes to the second visualization layer.

Example 2 is the computing system of any or all previous examples and further comprising:

API call identifier logic configured to identify the API call to be made to the API exposed by the data provider, based on the identified lens overlay.

Example 3 is the computing system of any or all previous examples wherein the lens overlay display identifier logic comprises:

a user selection detector configured to detect user actuation of a lens overlay actuator, on the baseline visualization display, corresponding to the identified lens overlay display.

Example 4 is the computing system of any or all previous examples and further comprising:

a security system configured to identify the user and determine whether the user is authorized to access the data corresponding to the identified lens overlay display and, if not, inhibit display of the data corresponding to the identified lens overlay display.

Example 5 is the computing system of any or all previous examples wherein the identified lens overlay display comprises visual elements that display a representation of the data corresponding to the identified lens overlay display.

Example 6 is the computing system of any or all previous examples wherein the identified lens overlay display generator is configured to access a configuration store to identify relative position information indicative of a position in which the visual elements in the identified lens overlay display are to be displayed, relative to a position of the visual elements in the baseline visualization display, and to generate the identified lens overlay display based on the relative position information.

Example 7 is the computing system of any or all previous examples wherein each of the visual elements in the baseline visualization display has a shape and wherein the lens overlay generator is configured to access the configuration store to identify an overlay-to-shape mapping that maps each of the visual elements in the identified lens overlay display to a shape of the visual elements in the baseline visualization display and to generate the lens overlay display based on the overlay-to-shape mapping.

Example 8 is the computing system of any or all previous examples and further comprising:

a rule identifier configured to identify rules applicable to the identified lens overlay display; and

execution logic configured to execute the identified rules based on the obtained data corresponding to the identified lens overlay display, to obtain a rule execution result.

Example 9 is the computing system of any or all previous examples wherein the lens overlay generator is configured to generate the lens overlay display based on the rule execution result.

Example 10 is a computing system, comprising:

a baseline visualization generator that generates a baseline visualization display, with visual elements, as a first visualization layer in a web application;

baseline visualization parsing logic that parses the baseline visualization display to identify the visual elements and a position of the visual elements in the baseline visualization display and generate baseline metadata indicative of the visual elements and a position of the visual elements in the baseline visualization display;

a data provider configuration system that configures a data provider to provide data for a lens overlay display corresponding to the baseline visualization display by generating a data provider configuration user interface and detecting user interactions with the data provider configuration user interface to obtain data source identifier information that identifies a data source from which the data is to be obtained to generate the lens overlay display, and to obtain connection data indicative of how the data provider is to connect to the data source, and by controlling a data provider configuration store to store the data source identifier information and the connection data, for access by the data provider; and

a lens configuration system that configures a lens overlay generation and display system to generate the lens overlay display as a second visualization layer in the web application, that is separate from the first visualization layer, so the visual elements in the first visualization layer remain unchanged by changes to visual elements in the second visualization layer, the lens configuration system configuring the lens overlay generation and display system by generating a lens configuration user interface and detecting user interaction with the lens configuration user interface to receive application programming interface (API) call identifier data that identifies an API call that the lens overlay generation and display system is to make to an API exposed by the data provider to obtain the data for the lens overlay display, and to receive mapping data indicative of how a visual element in the lens overlay display maps to the visual elements in the baseline visualization display, based on the baseline metadata and controls a lens configuration store to the API call identifier data and the mapping data for access by the lens overlay generation and display system.

Example 11 is the computing system of any or all previous examples and further comprising:

a configuration actuation detector configured to detect user actuation of a configuration actuator on the baseline visualization display and to generate a configuration signal indicative of the selected user actuation, to trigger at least one of the data provider configuration system to configure the data provider and the lens configuration system to configure the lens overlay and generation and display system.

Example 12 is the computing system of any or all previous examples wherein the data provider configuration system comprises:

operation rules logic configured to detect user interactions with the data provider configuration user interface to obtain rules information that defines a rule executed on the data to be obtained to generate the lens overlay display and to store the rules information for access by the data provider.

Example 13 is the computing system of any or all previous examples wherein the lens configuration system comprises:

shape configuration logic configured to detect user interaction with the lens configuration user interface to receive shape data that identifies a shape in which data is to be displayed in the lens overlay display, the mapping data indicating how the shape maps to a visual element in the baseline visualization display, and to store the shape data for access by the lens overlay generation and display system.

Example 14 is the computing system of any or all previous examples wherein the lens configuration system comprises:

relative position logic configured to detect user interaction with the lens configuration user interface to receive relative position data that identifies a position on the baseline visualization that the shape in the lens overlay display is to be displayed, relative to a position of the visual element in the baseline visualization display that the shape is mapped to and to store the relative position data for access by the lens overlay generation and display system.

Example 15 is the computing system of any or all previous examples wherein the lens configuration system comprises:

rules logic configured to detect user interaction with the lens configuration user interface to receive rules data that defines a shape appearance rule indicative of an appearance of the shape, based on the data displayed in the shape and to store the rules data for access by the lens overlay generation and display system.

Example 16 is a computer implemented method, comprising:

generating a baseline visualization display, with visual elements, as a first visualization layer in a web application;

identifying a lens overlay display corresponding to the baseline visualization display;

making an application programming interface (API) call to an API, exposed by a data provider, to obtain data corresponding to the identified lens overlay display; and

receiving the data corresponding to the identified lens overlay display in response to the API call; and

generating the identified lens overlay display including the received data, so the generated lens overlay is displayed concurrently with the baseline visualization display, as a second visualization layer in the web application, that is independently modifiable, independently of the first visualization layer, so the visual elements in the first visualization layer remain unchanged by changes to the second visualization layer.

Example 17 is the computer implemented method of any or all previous examples and further comprising:

identifying the API call to be made to the API exposed by the data provider, based on the identified lens overlay.

Example 18 is the computer implemented method of any or all previous examples wherein identifying the lens overlay display comprises:

detecting user actuation of a lens overlay actuator, on the baseline visualization display, corresponding to the identified lens overlay display.

Example 19 is the computer implemented method of any or all previous examples and further comprising:

identifying the user;

determining whether the user is authorized to access the data corresponding to the identified lens overlay display; and

if not, inhibiting display of the data corresponding to the identified lens overlay display.

Example 20 is the computer implemented method of any or all previous examples wherein the identified lens overlay display comprises visual elements that display a representation of the data corresponding to the identified lens overlay display, and wherein generating the identified lens overlay display comprises:

accessing a configuration store to identify relative position information indicative of a position in which the visual elements in the identified lens overlay display are to be displayed, relative to a position of the visual elements in the baseline visualization display; and

generating the identified lens overlay display based on the relative position information.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing system, comprising:
a baseline visualization generator that generates a baseline visualization display, with visual elements, as a first visualization layer in a web application;
lens overlay display identifier logic that identifies a lens overlay display corresponding to the baseline visualization display;
application programming interface (API) interaction logic that makes an API call to an API, exposed by a data provider, to obtain data corresponding to the identified lens overlay display; and
a lens overlay display generator that receives the data corresponding to the identified lens overlay display and generates the identified lens overlay display including the received data, so the generated lens overlay is displayed concurrently with the baseline visualization display, as a second visualization layer in the web application, that is independently modifiable, independently of the first visualization layer, so the visual elements in the first visualization layer remain unchanged by changes to the second visualization layer.

2. The computing system of claim 1 and further comprising:
API call identifier logic configured to identify the API call to be made to the API exposed by the data provider, based on the identified lens overlay.

3. The computing system of claim 2 wherein the lens overlay display identifier logic comprises:
a user selection detector configured to detect user actuation of a lens overlay actuator, on the baseline visualization display, corresponding to the identified lens overlay display.

4. The computing system of claim 3 and further comprising:
a security system configured to identify the user and determine whether the user is authorized to access the data corresponding to the identified lens overlay display and, if not, inhibit display of the data corresponding to the identified lens overlay display.

5. The computing system of claim 4 wherein the identified lens overlay display comprises visual elements that display a representation of the data corresponding to the identified lens overlay display.

6. The computing system of claim 5 wherein the identified lens overlay display generator is configured to access a configuration store to identify relative position information indicative of a position in which the visual elements in the identified lens overlay display are to be displayed, relative to a position of the visual elements in the baseline visualization display, and to generate the identified lens overlay display based on the relative position information.

7. The computing system of claim 6 wherein each of the visual elements in the baseline visualization display has a shape and wherein the lens overlay generator is configured to access the configuration store to identify an overlay-to-shape mapping that maps each of the visual elements in the identified lens overlay display to a shape of the visual elements in the baseline visualization display and to generate the lens overlay display based on the overlay-to-shape mapping.

8. The computing system of claim 5 and further comprising:
a rule identifier configured to identify rules applicable to the identified lens overlay display; and
execution logic configured to execute the identified rules based on the obtained data corresponding to the identified lens overlay display, to obtain a rule execution result.

9. The computing system of claim 8 wherein the lens overlay generator is configured to generate the lens overlay display based on the rule execution result.

10. A computing system, comprising:
a baseline visualization generator that generates a baseline visualization display, with visual elements, as a first visualization layer in a web application;
baseline visualization parsing logic that parses the baseline visualization display to identify the visual elements and a position of the visual elements in the baseline visualization display and generate baseline metadata indicative of the visual elements and a position of the visual elements in the baseline visualization display;
a data provider configuration system that configures a data provider to provide data for a lens overlay display corresponding to the baseline visualization display by generating a data provider configuration user interface and detecting user interactions with the data provider configuration user interface to obtain data source identifier information that identifies a data source from which the data is to be obtained to generate the lens overlay display, and to obtain connection data indicative of how the data provider is to connect to the data source, and by controlling a data provider configuration store to store the data source identifier information and the connection data, for access by the data provider; and
a lens configuration system that configures a lens overlay generation and display system to generate the lens overlay display as a second visualization layer in the web application, that is separate from the first visualization layer, so the visual elements in the first visualization layer remain unchanged by changes to visual elements in the second visualization layer, the lens configuration system configuring the lens overlay generation and display system by generating a lens configuration user interface and detecting user interaction with the lens configuration user interface to receive application programming interface (API) call identifier data that identifies an API call that the lens overlay generation and display system is to make to an API exposed by the data provider to obtain the data for the lens overlay display, and to receive mapping data indicative of how a visual element in the lens overlay display maps to the visual elements in the baseline visualization display, based on the baseline metadata and controls a lens configuration store to the API call identifier data and the mapping data for access by the lens overlay generation and display system.

11. The computing system of claim 10 and further comprising:
a configuration actuation detector configured to detect user actuation of a configuration actuator on the baseline visualization display and to generate a configuration signal indicative of the selected user actuation, to trigger at least one of the data provider configuration system to configure the data provider and the lens configuration system to configure the lens overlay and generation and display system.

12. The computing system of claim 11 wherein the data provider configuration system comprises:
operation rules logic configured to detect user interactions with the data provider configuration user interface to obtain rules information that defines a rule executed on the data to be obtained to generate the lens overlay display and to store the rules information for access by the data provider.

13. The computing system of claim 12 wherein the lens configuration system comprises:
shape configuration logic configured to detect user interaction with the lens configuration user interface to receive shape data that identifies a shape in which data is to be displayed in the lens overlay display, the mapping data indicating how the shape maps to a visual element in the baseline visualization display, and to store the shape data for access by the lens overlay generation and display system.

14. The computing system of claim 13 wherein the lens configuration system comprises:
relative position logic configured to detect user interaction with the lens configuration user interface to receive relative position data that identifies a position on the baseline visualization that the shape in the lens overlay display is to be displayed, relative to a position of the visual element in the baseline visualization display that the shape is mapped to and to store the relative position data for access by the lens overlay generation and display system.

15. The computing system of claim 13 wherein the lens configuration system comprises:
rules logic configured to detect user interaction with the lens configuration user interface to receive rules data that defines a shape appearance rule indicative of an appearance of the shape, based on the data displayed in the shape and to store the rules data for access by the lens overlay generation and display system.

16. A computer implemented method, comprising:
generating a baseline visualization display, with visual elements, as a first visualization layer in a web application;
identifying a lens overlay display corresponding to the baseline visualization display;
making an application programming interface (API) call to an API, exposed by a data provider, to obtain data corresponding to the identified lens overlay display; and
receiving the data corresponding to the identified lens overlay display in response to the API call; and
generating the identified lens overlay display including the received data, so the generated lens overlay is displayed concurrently with the baseline visualization display, as a second visualization layer in the web application, that is independently modifiable, independently of the first visualization layer, so the visual elements in the first visualization layer remain unchanged by changes to the second visualization layer.

17. The computer implemented method of claim 16 and further comprising:
identifying the API call to be made to the API exposed by the data provider, based on the identified lens overlay.

18. The computer implemented method of claim 17 wherein identifying the lens overlay display comprises:
detecting user actuation of a lens overlay actuator, on the baseline visualization display, corresponding to the identified lens overlay display.

19. The computer implemented method of claim 18 and further comprising:
identifying the user;
determining whether the user is authorized to access the data corresponding to the identified lens overlay display; and
if not, inhibiting display of the data corresponding to the identified lens overlay display.

20. The computer implemented method of claim 19 wherein the identified lens overlay display comprises visual elements that display a representation of the data corresponding to the identified lens overlay display, and wherein generating the identified lens overlay display comprises:
accessing a configuration store to identify relative position information indicative of a position in which the visual elements in the identified lens overlay display are to be displayed, relative to a position of the visual elements in the baseline visualization display; and
generating the identified lens overlay display based on the relative position information.
